(19) United States
(12) Patent Application Publication
(10) Pub. No.: US 2025/0065586 A1
(43) Pub. Date: Feb. 27, 2025

(54) PRESSING DEVICE, TREATMENT DEVICE, AND TREATMENT SYSTEM

(71) Applicant: MITSUBISHI HEAVY INDUSTRIES, LTD., Tokyo (JP)

(72) Inventor: Tomohiro MURAI, Tokyo (JP)

(21) Appl. No.: 18/749,858

(22) Filed: Jun. 21, 2024

(30) Foreign Application Priority Data
Aug. 23, 2023 (JP) 2023-135692

(51) Int. Cl. B30B 15/16; B30B 15/24; B64F 5/40

(52) U.S. Cl. CPC B30B 15/165; B30B 15/24; B64F 5/40

(57) ABSTRACT

A pressing device includes: a plurality of pressing portions each configured to generate a pressing force toward a treatment target surface facing in a first direction and arranged in a direction intersecting the first direction; and an interlocking mechanism configured to interlock the plurality of pressing portions and control a pressing amount of each of the pressing portions in the first direction. For example, each of the pressing portions is a fluid device configured to be deformed by a pressure of an internal fluid to generate the pressing force in the first direction, and the interlocking mechanism includes a fluid supply portion configured to supply a fluid to a plurality of the fluid devices and a plurality of speed control valves provided for the respective plurality of the fluid devices and configured to adjust a supply rate of the fluid to each of the fluid devices.

### CROSS-REFERENCE TO RELATED APPLICATIONS

This application claims the benefit of priority to Japanese Patent Application Number 2023-135692 filed on Aug. 23, 2023. The entire contents of the above-identified application are hereby incorporated by reference.

### TECHNICAL FIELD

The disclosure relates to a pressing device, a treatment device, and a treatment system.

### RELATED ART

JP 2020-104443 A discloses a structure of a wing of an aircraft. The wing includes a skin and a stringer. The skin and the stringer are laid on top of each other. The stringer includes a connection portion connected to the skin and a projection separated from the skin. A hollow portion is formed between the projection and the skin.

Japanese Patent No. 6071359 discloses a method of repairing a defect by applying sealant by manual operation using a brush.

### SUMMARY

Here, a defect may occur at the hollow portion between the skin and the stringer. In that case, the location where the defect occurs is very narrow, making it difficult to uniformly press the brush by the manual operation described above. This causes a problem in that brush marks remain on the sealant.

In addition, not only a treatment of cleaning a wing and a sanding treatment of polishing the wing but also a fusing treatment and a compaction treatment have difficulty in uniformly obtaining a pressing force.

The disclosure has been made to solve the above problem, and an object of the disclosure is to provide a pressing device, treatment device, and a treatment system that can generate a pressing force uniformly.

To solve the above-described problem, a pressing device according to the disclosure includes: a plurality of pressing portions each configured to generate a pressing force toward a treatment target surface facing in a first direction and arranged in a direction intersecting the first direction; and an interlocking mechanism configured to interlock the plurality of pressing portions and control a pressing amount of each of the pressing portions in the first direction.

A treatment device according to the disclosure includes: the pressing device described above; and a treatment portion configured to treat the treatment target surface by being applied with the pressing force in the first direction and pressed against the treatment target surface by the pressing portions.

A treatment system according to the disclosure includes: the treatment device described above; a pipe coupled to the treatment device from a second direction intersecting the first direction; and a movement mechanism that holds an end portion of the pipe on a side opposite to the treatment device in the second direction and moves the pipe in the second direction.

The pressing device, the treatment device, and the treatment system of the disclosure can uniformly generate a pressing force.

### BRIEF DESCRIPTION OF DRAWINGS

The disclosure will be described with reference to the accompanying drawings, wherein like numbers reference like elements.

FIG. 1 is a side view illustrating a schematic configuration of a treatment system according to a first embodiment of the disclosure.

FIG. 2 is a plan view illustrating a schematic configuration of an automation device according to the first embodiment of the disclosure.

FIG. 3 is a perspective view illustrating a part of a target object according to the first embodiment of the disclosure.

FIG. 4 is a cross-sectional view illustrating a schematic configuration of a coupling member according to the first embodiment of the disclosure.

FIG. 5 is a schematic diagram illustrating a schematic configuration of a treatment device according to the first embodiment of the disclosure.

FIG. 6 is a flowchart illustrating a procedure of a treatment method according to the first embodiment of the disclosure.

FIG. 7 is a schematic diagram illustrating a schematic configuration of a treatment device according to a first modification example of the first embodiment of the disclosure.

FIG. 8 is a schematic diagram illustrating a schematic configuration of a treatment device according to a second modification example of the first embodiment of the disclosure.

FIG. 9 is a schematic diagram illustrating a schematic configuration of a treatment device according to a third modification example of the first embodiment of the disclosure.

FIG. 10 is a schematic diagram illustrating a schematic configuration of a treatment device according to a fourth modification example of the first embodiment of the disclosure.

FIG. 11 is a schematic diagram illustrating a schematic configuration of a treatment device according to a second embodiment of the disclosure.

FIG. 12 is a schematic diagram illustrating a schematic configuration of the treatment device according to the second embodiment of the disclosure.

FIG. 13 is a schematic diagram illustrating a schematic configuration of a treatment device according to a modification example of the second embodiment of the disclosure.

FIG. 14 is a schematic diagram illustrating a schematic configuration of a treatment device according to a third embodiment of the disclosure.

FIG. 15 is a function block diagram illustrating a functional configuration of a control unit according to the third embodiment of the disclosure.

FIG. 16 is a flowchart illustrating a procedure of controlling each pressing amount according to the third embodiment of the disclosure.

FIG. 17 is a hardware configuration diagram according to an embodiment of the disclosure.

### DESCRIPTION OF EMBODIMENTS

### First Embodiment

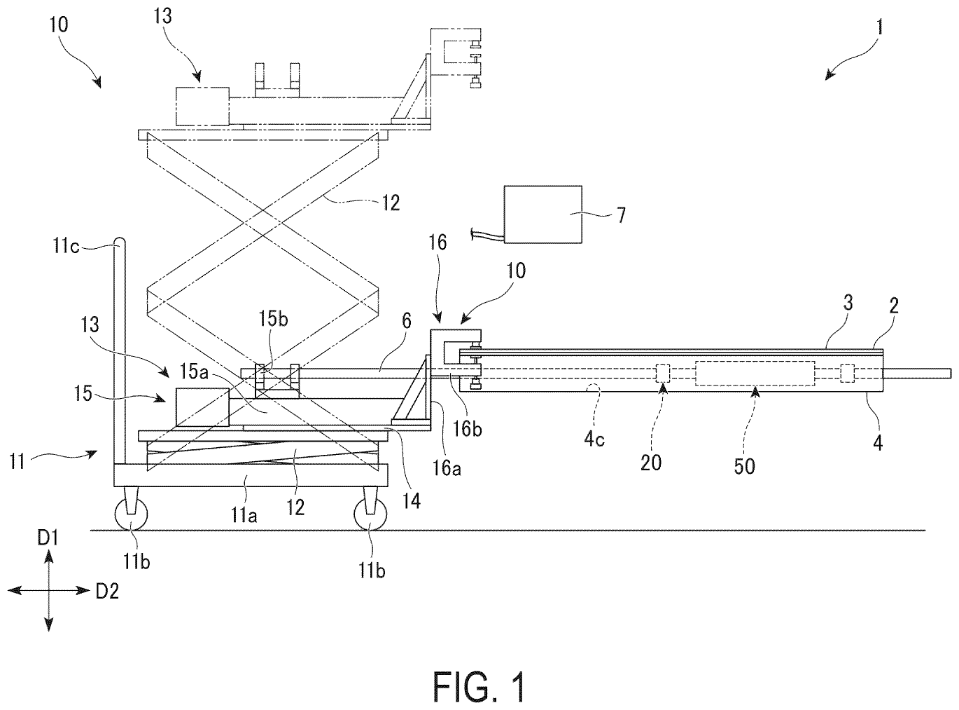

A pressing device 60, a treatment device 50, and a treatment system 1 according to an embodiment of the disclosure will be described below with reference to FIGS. 1 to 6.

### Treatment System

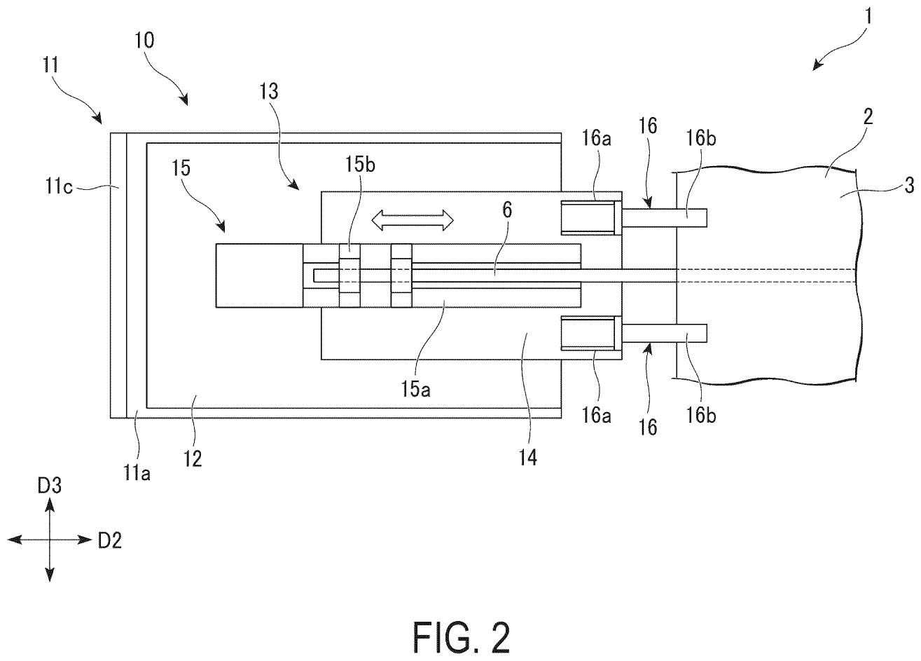

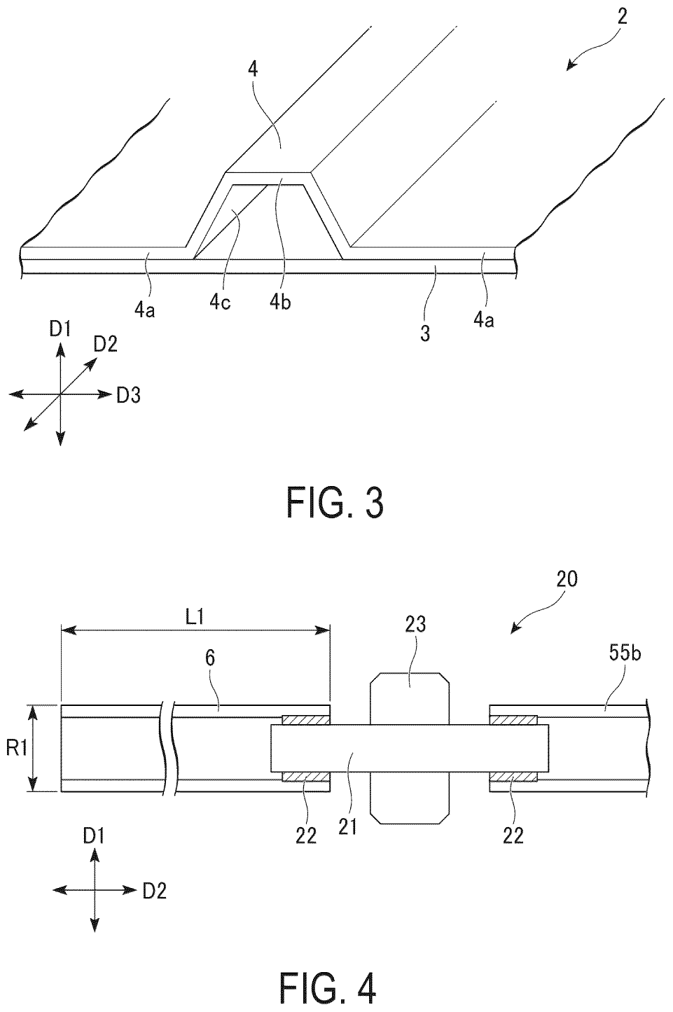

The treatment system 1 (see FIGS. 1 and 2) is used, for example, for repairing a wing of an aircraft. Hereinafter, the wing to be repaired is referred to as a target object 2. As illustrated in FIG. 3, the target object 2 includes a skin 3 and a stringer 4.

The skin 3 constitutes an outer shell of a wing of an aircraft. The skin 3 is formed in a flat plate shape, for example. The stringer 4 is attached to the skin 3. The stringer 4 includes a connection portion 4a connected to the skin 3 and a projection 4b separated from the skin 3. The connection portion 4a is located on a side closer to the skin 3 with respect to the projection 4b. The projection 4b is located on a side away from the skin 3 with respect to the connection portion 4a.

A hollow portion (hereinafter referred to as a narrow portion 4c) is formed between the projection 4b and the skin 3. The stringer 4 is, for example, a hat stringer having a hat shape. The skin 3 and the stringer 4 are made of a composite material such as glass fiber reinforced plastics (GFRP) or carbon fiber reinforced plastics (CFRP).

The treatment system 1 illustrated in FIGS. 1 and 2 is used for repairing the narrow portion 4c between the projection 4b and the skin 3. The treatment system 1 performs brush coating by applying a sealing material to a defect caused at a surface of the skin 3 (hereinafter referred to as a treatment target surface 5) in the narrow portion 4c using a brush 84 to be described below (seal repairing treatment).

The treatment system 1 includes the treatment device 50, an automation device 10, a pipe 6, and a coupling member 20. The treatment device 50 is moved in the narrow portion 4c by the automation device 10 to be described below in a state of being inserted into the narrow portion 4c so as to apply the sealing material to the treatment target surface 5. A detailed configuration of the treatment device 50 will be described below.

In the following description, three directions intersecting each other are referred to as a first direction D1, a second direction D2, and a third direction D3, respectively. In the present embodiment, the first direction D1, the second direction D2, and the third direction D3 are orthogonal to each other, the first direction D1 is orthogonal to a horizontal plane, and the second direction D2 and the third direction D3 are along the horizontal plane. The first direction D1 may be slightly inclined with respect to the horizontal plane, and the second direction D2 and the third direction D3 may slightly intersect the horizontal plane. In the following description, the first direction D1 may be referred to as an up-down direction, the second direction D2 may be referred to as a front-back direction, and the third direction D3 may be referred to as a left-right direction.

### Automation Device

The automation device 10 automatically moves the treatment device 50 in the second direction D2. The automation device 10 includes a cart 11, a jack 12, and an automation device main body 13.

### Cart

The cart 11 moves the jack 12 and the automation device main body 13. The cart 11 includes a body 11a, a caster 11b, and a handle 11c.

The body 11a is disposed at a position slightly above a floor surface and extends in the horizontal direction. The body 11a is formed in a rectangular shape extending in the second direction D2 (the front-back direction) when viewed in the first direction D1 (the up-down direction).

The caster 11b is provided at each of four corners of the body 11a when viewed in the first direction D1. The casters 11b are attached to a bottom surface of the body 11a. Each of the casters 11b is provided so as to be capable of rolling on the floor surface. The four casters 11b support the body 11a from below.

The handle 11c is provided at an end portion of the body 11a on one side in the second direction D2 (the back side in the front-back direction). The handle 11c extends upward from the body 11a. An operator grips the handle 11c to move the cart 11.

### Jack

The jack 12 is placed on the body 11a of the cart 11. The automation device main body 13 is placed on the jack 12. The jack 12 is provided so as to be expandable and contractible in the first direction D1. The position of the automation device main body 13 in the first direction D1 is adjusted by the jack 12 expanding and contracting in the first direction D1.

### Automation Device Main Body

The automation device main body 13 includes a baseplate 14, a movement mechanism 15, and a clamp mechanism 16.

The baseplate 14 is placed on the jack 12.

### Movement Mechanism

The movement mechanism 15 is placed on the baseplate 14. The pipe 6 coupled to the treatment device 50 is connected to the movement mechanism 15. The pipe 6 extends in the second direction D2. The movement mechanism 15 grips an end portion of the pipe 6 on a side opposite to the treatment device 50 in the second direction D2 to move the pipe 6 in the second direction D2. The movement mechanism 15 is, for example, an electric actuator, and includes a base 15a and an actuation unit 15b. The base 15a extends in the second direction D2. The actuation unit 15b is attached to the base 15a. One end portion of the pipe 6 in the second direction D2 is fixed to the actuation unit 15b. The actuation unit 15b moves on the base 15a in the second direction D2. As the actuation unit 15b moves in the second direction D2, the pipe 6 moves in the second direction D2, and the treatment device 50 coupled to the pipe 6 also moves in the second direction D2 in conjunction therewith.

### Clamp Mechanism

The clamp mechanism 16 is provided at an end portion of the baseplate 14 on the other side in the second direction D2 (the front side in the front-back direction). A pair of clamp mechanisms 16 is provided so as to sandwich the movement mechanism 15 in the third direction D3 (the left-right direction). The clamp mechanism 16 includes a leg portion 16a standing upward from the baseplate 14 and a clamping part 16b provided at an upper end of the leg portion 16a. The leg portion 16a supports the clamping part 16b from below. The clamping part 16b sandwiches the target object 2 from both sides in the first direction D1 (the up-down direction). This prevents the displacement of the target object 2 in the horizontal direction.

The two clamp mechanisms 16 may be disposed to be shifted from each other in the second direction D2. With this arrangement, the automation device 10 can be used even when the end portion of the target object 2 on the clamp mechanism 16 side is inclined with respect to the third direction D3.

### Pipe

The pipe 6 extends in the second direction D2 from the actuation unit 15b of the movement mechanism 15 toward the treatment device 50. The pipe 6 is coupled to the treatment device 50 from the second direction D2. The pipe 6 transmits power for moving the treatment device 50 disposed in the narrow portion 4c between the skin 3 and the stringer 4 in the second direction D2 (the front-back direction). In the illustrated example, a pair of pipes 6 is provided, one on either side in the second direction D2 (the front-back direction) with respect to the treatment device 50, and the automation device 10 is provided only at the pipe 6 on one side in the second direction D2 (the front side in the front-back direction). The pipe 6 may be provided only on one side (the front side in the front-back direction) of the treatment device 50 in the second direction D2. The automation device 10 may be provided at each of the two pipes 6.

A length L1 of the pipe 6 in the second direction D2 is designed to be, for example, 1.5 m or more and 2.5 m or less, and an outside diameter R1 of the pipe 6 is designed to be, for example, 20 mm or more and 25 mm or less.

### Coupling Member

The coupling member 20 couples the pipe 6 with a coupling pipe 51 extending from the treatment device 50 in the second direction D2.

The coupling member 20 includes a central shaft portion 21, male thread portions 22, and a flange portion 23.

### Central Shaft Portion

The central shaft portion 21 extends in the second direction D2. One end portion of the central shaft portion 21 in the second direction D2 is inserted into one of the pipe 6 and the coupling pipe 51. The other end portion in the second direction D2 is inserted into the other of the pipe 6 and the coupling pipe 51. In the illustrated example, the end portion of the central shaft portion 21 on the back side is inserted into the pipe 6, and the end portion of the central shaft portion 21 on the front side is inserted into the coupling pipe 51.

### Male Thread Portion

The male thread portions 22 are provided at both the end portions of the central shaft portion 21 in the second direction D2. The male thread portions 22 are designed to be threadably engaged with the inside surfaces of the pipe 6 and the coupling pipe 51. The outside diameter of the male thread portion 22 is formed to be slightly larger than the inside diameter of the pipe 6 and the inside diameter of the coupling pipe 51. Thus, the coupling member 20 is firmly coupled to the pipe 6 and the coupling pipe 51.

### Flange Portion

The flange portion 23 protrudes from an outside surface of the central shaft portion 21 at a central portion in the second direction D2 outward in the radial direction with respect to the pipe 6 and the coupling pipe 51. The flange portion 23 is formed of a material (resin or the like) having a hardness lower than the hardness of the treatment target surface 5. The flange portion 23 prevents the pipe 6 and the coupling pipe 51 from coming into contact with an inner surface (the treatment target surface 5 or the like) of the narrow portion 4c of the target object 2 including the skin 3 and the stringer 4. Instead of the flange portion 23, a material having a low hardness such as a film or a rubber may be wound around the pipe 6 and the coupling pipe 51. With such means, it is also possible to prevent the pipe 6 and the coupling pipe 51 from coming into contact with and causing damage to the inner surface of the narrow portion 4c.

### Configuration of Treatment Device

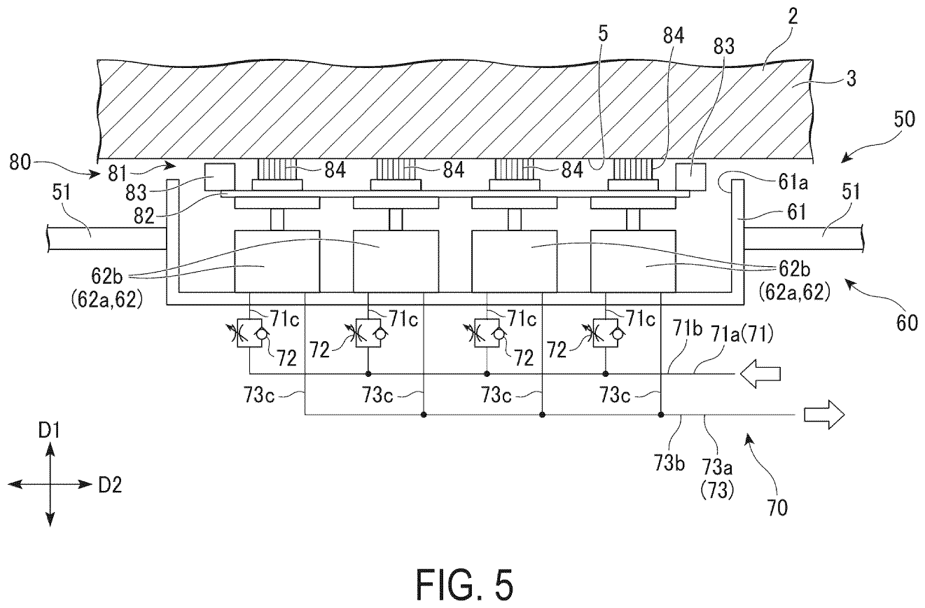

The treatment device 50 is disposed in the narrow portion 4c of the target object 2. The treatment device 50 (which is inserted into the narrow portion 4c from the second direction D2 in the illustrated example) repairs the treatment target surface 5 at which a defect is caused. As illustrated in FIG. 5, the treatment device 50 includes the pressing device 60, a treatment portion 80, and the coupling pipes 51.

### Pressing Device

The pressing device 60 includes a casing 61, a pressing portion 62, and an interlocking mechanism 70.

### Casing

The casing 61 extends in the second direction D2. The casing 61 is formed in a box shape including an opening 61a that opens in the first direction D1. The casing 61 is formed in a cubic shape extending in the second direction D2, for example.

### Pressing Portion

A plurality of pressing portions 62 is accommodated in the casing 61. The pressing portions 62 are arranged at the bottom surface of the casing 61 in a direction intersecting the first direction D1. In the illustrated example, the plurality of pressing portions 62 is disposed at regular intervals in the second direction D2. The plurality of pressing portions 62 may be disposed in the third direction D3. Each of the plurality of pressing portions 62 generates a pressing force toward the treatment target surface 5 facing in the first direction D1.

The pressing portion 62 of the present embodiment is a fluid device 62a that is deformed by a pressure of an internal fluid to generate a pressing force in the first direction D1. More specifically, the fluid device 62a is a fluid cylinder 62b that expands and contracts in the first direction D1 by the pressure of the internal fluid to generate a pressing force in the first direction D1 when expanding. The fluid cylinder 62b is, for example, an air cylinder using air as a working fluid. The fluid cylinder 62b may be a hydraulic cylinder using oil as a working fluid.

### Interlocking Mechanism

The interlocking mechanism 70 interlocks the plurality of pressing portions 62 to control the pressing amount of each of the fluid devices 62a in the first direction D1. The interlocking mechanism 70 of the present embodiment includes a fluid supply portion 71, a speed control valve 72, and a fluid discharge portion 73.

### Fluid Supply Portion

The fluid supply portion 71 supplies a fluid to each of the plurality of fluid devices 62a. The fluid supply portion 71 includes a supply line 71a. The supply line 71a is connected to a supply source (not illustrated) of the fluid. The supply line 71a includes a first supply line 71b extending from the supply source of the fluid and a plurality of second supply lines 71c branching off from the first supply line 71b. The second supply line 71c is provided for each of the fluid devices 62a. Each of the second supply lines 71c connects the first supply line 71b and the corresponding fluid device 62a. Each of the fluid devices 62a is supplied with the fluid via the supply line 71a.

### Speed Control Valve

The speed control valve 72 is provided for each of the plurality of fluid devices 62a. The speed control valve 72 is a so-called speed controller and is provided at each of the second supply lines 71c. The speed control valve 72 can adjust the supply rate of the fluid to each of the fluid devices 62a by changing an orifice diameter.

### Fluid Discharge Portion

The fluid discharge portion 73 discharges the fluid from each of the plurality of fluid devices 62a. The fluid discharge portion 73 includes a discharge line 73a. The discharge line 73a includes a first discharge line 73b and a plurality of second discharge lines 73c provided, one for each of the fluid devices 62a. Each of the second discharge lines 73c connects the corresponding fluid device 62a and the first discharge line 73b. The fluid is discharged from each of the fluid devices 62a via the discharge line 73a. The fluid may be discharged to a supply source (not illustrated) of the fluid supply portion 71 or may be discharged to the outside of the treatment system 1.

### Treatment Portion

The treatment portion 80 performs a predetermined treatment on the treatment target surface 5 by being applied with a pressing force in the first direction D1 and pressed against the treatment target surface 5 by the pressing portions 62. The treatment portion 80 of the present embodiment is a brush portion 81 that performs a seal repairing treatment (brush coating treatment) on the treatment target surface 5 by applying a sealing material to the treatment target surface 5.

### Brush Portion

The brush portion 81 includes a base 82, a guide 83, and a brush 84. The base 82 is placed on the plurality of pressing portions 62 (the fluid devices 62a). The base 82 extends in the second direction D2.

### Guide

The guide 83 is attached to either end portion of the base 82 in the second direction D2. The guide 83 protrudes from the opening of the casing 61 in the first direction D1. The guide 83 is slidable with respect to the treatment target surface 5. The brush 84 is prevented from being excessively pressed against the treatment target surface 5 by the guide 83 coming into contact with the treatment target surface 5.

### Brush

A plurality of brushes 84 are attached to the base 82. Each of the brushes 84 slightly protrudes from the opening of the casing 61 in the first direction D1 beyond the guides 83. The plurality of brushes 84 is arranged at regular intervals in the second direction D2. The brush 84 is provided at a position overlapping with each of the fluid devices 62a in the first direction D1. The brushes 84 extend toward the treatment target surface 5 and apply the sealing material to the treatment target surface 5.

### Coupling Pipe

The coupling pipes 51 are arranged side by side in the second direction D2 with respect to the casing 61. The coupling pipes 51 extend in the second direction D2 so as to be separated from end portions of the casing 61 in the second direction D2. The coupling pipes 51 are coupled to the pipes 6 via the coupling members 20 described above.

### Controller

A controller 7 is connected to the treatment device 50 by a cable (not illustrated). The controller 7 may be wirelessly connected to the treatment device 50. For example, an operator can operate the controller 7 to control the supply of the fluid to the fluid devices 62a.

### Procedure of Treatment Method

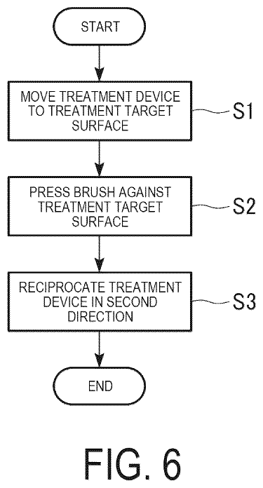

A treatment method according to the present embodiment will be described with reference to the flowchart of FIG. 6. The treatment described here is, for example, a treatment (a seal repairing treatment) in which when a defect occurs at the narrow portion 4c between the skin 3 and the stringer 4 constituting the target object 2 (for example, a wing of an aircraft), the treatment target surface 5 is coated by applying a sealing material with the brushes 84.

First, in a state in which the target object 2 is arranged such that the skin 3 is on the upper side and the stringer 4 is on the lower side, the automation device 10 is operated to insert the treatment device 50 into the narrow portion 4c from the second direction D2 and move the treatment device 50 to the treatment target surface 5 to be repaired (step S1).

After step S1, air is supplied into the fluid devices 62a to press the brushes 84 against the treatment target surface 5 in the first direction D1 (step S2). In step S2, when an excessive pressing force is applied to the brushes 84, the guides 83 come into contact with the treatment target surface 5 to prevent the brushes 84 from being excessively pressed.

After step S2, the treatment device 50 is moved in the second direction D2 in a state in which the brushes 84 are pressed (step S3). In step S3, the movement mechanism 15 of the automation device 10 is operated to reciprocate the treatment device 50 in the second direction D2.

Through the above-described procedure, the sealing material is applied to the treatment target surface 5, and the brush coating is completed.

### Operational Effects

In the present embodiment, the following effects are achieved.

According to the present embodiment, the pressing device 60 includes: the plurality of pressing portions 62 configured to generate a pressing force toward the treatment target surface 5 facing in the first direction D1 and arranged in a direction intersecting the first direction D1; and the interlocking mechanism 70 configured to interlock the plurality of pressing portions 62 and control a pressing amount of each of the pressing portions 62 in the first direction D1.

This can generate a pressing force in the first direction D1 uniformly in the direction intersecting the first direction D1 (the second direction D2 in the present embodiment).

The pressing portion 62 of the present embodiment is a fluid device 62a that is deformed by a pressure of an internal fluid to generate a pressing force in the first direction D1. The interlocking mechanism 70 includes the fluid supply portion 71 that supplies the fluid to each of the plurality of fluid devices 62a, and the plurality of speed control valves 72 provided for the respective plurality of the fluid devices 62a and adjust the supply rate of the fluid to each fluid device 62a.

Before the pressing device 60 is installed at a position facing the treatment target surface 5, the speed control valves 72 can be operated to control the supply rate of the fluid to each of the fluid devices 62a and the internal pressure of each fluid device 62a. For example, the supply rates of the fluid to the fluid devices 62a can be made uniform. This allows the deformation speeds to coincide with each other in the plurality of fluid devices 62a.

The fluid device 62a of the present embodiment is the fluid cylinder 62b that expands and contracts in the first direction D1 by the pressure of the internal fluid to generate a pressing force in the first direction D1 when expanding.

The fluid cylinder 62b is deformed only in the first direction D1 by the pressure of the fluid. Thus, the pressure of the fluid can be efficiently converted into a pressing force.

The treatment device 50 includes the pressing device 60 and the treatment portion 80 that performs a predetermined treatment on the treatment target surface 5 by being applied with a pressing force in the first direction D1 and pressed against the treatment target surface 5 by the pressing portions 62.

This allows the treatment portion 80 to be pressed against the treatment target surface 5 while the orientation of the treatment portion 80 is maintained such that a surface of the treatment portion 80 on the treatment target surface 5 side is parallel to the treatment target surface 5. Thus, the treatment portion 80 can be uniformly pressed against the treatment target surface 5 to uniformly treat the entire treatment target surface 5. In the present embodiment, all the brushes 84 are brought into contact with the treatment target surface 5 in the same orientation, so that the sealing material can be uniformly applied.

In the present embodiment, the treatment portion 80 is the brush portion 81 including the brushes 84 that extend toward the treatment target surface 5 and apply the sealing material to the treatment target surface 5.

This allows all the brushes 84 to be brought into contact with the treatment target surface 5 in the same orientation, so that the sealing material can be uniformly applied. This enables the seal repairing treatment to be easily performed with a high accuracy.

According to the present embodiment, the treatment system 1 includes the treatment device 50, the pipe 6 coupled to the treatment device 50 from the second direction D2 intersecting the first direction D1, and the movement mechanism 15 that holds an end portion of the pipe 6 on a side opposite to the treatment device 50 in the second direction D2 and moves the pipe 6 in the second direction D2.

This can automatically move the treatment device 50 in the second direction D2. For example, as in the present embodiment, the entire seal repairing treatment can be automated so that the seal repairing treatment can be efficiently performed.

In the present embodiment, the treatment device 50 further includes the coupling pipe 51 extending in the second direction D2. The treatment system 1 further includes the coupling member 20 that couples the pipe 6 and the coupling pipe 51. The coupling member 20 includes: the central shaft portion 21 that extends in the second direction D2 and has one end portion in the second direction D2 inserted into one of the pipe 6 and the coupling pipe 51 and the other end portion in the second direction D2 inserted into the other of the pipe 6 and the coupling pipe 51; the male thread portions 22 provided at both the end portions of the central shaft portion 21 in the second direction D2 and threadably engaged with the inside surfaces of the pipe 6 and the coupling pipe 51; and the flange portion 23 that protrudes from an outside surface of the central shaft portion 21 at a central portion in the second direction D2 outward in the radial direction with respect to the pipe 6 and the coupling pipe 51.

The coupling member 20 is firmly fixed to both the pipe 6 and the coupling pipe 51 of the treatment device 50 by the male thread portions 22. The flange portion 23 protrudes outward in the radial direction beyond the pipe 6 and the coupling pipe 51. Thus, the pipe 6 and the coupling pipe 51 can be prevented from colliding with peripheral members (the treatment target surface 5 and the like). Further, in the present embodiment, since the flange portion 23 is formed of a material having a hardness lower than the hardness of the treatment target surface 5, even when the flange portion 23 comes into contact with the treatment target surface 5, damages to the treatment target surface 5 can be avoided.

In the present embodiment, the length L1 of the pipe 6 in the second direction D2 is designed to be, for example, 1.5 m or more and 2.5 m or less, and the outside diameter R1 of the pipe 6 is designed to be, for example, 20 mm or more and 25 mm or less.

Since the cross-sectional dimensions (the length L1 and the outside diameter R1) of the pipe 6 are designed as described above, the pipe 6 can achieve a flexibility that enables the pipe 6 to follow the curved surface shape of the target object 2 (a wing of an aircraft in the present embodiment) and robustness that prevents the pipe 6 from being buckled when pressed in the second direction D2. From the viewpoint of achieving both flexibility and robustness, the length L1 of the pipe 6 is most preferably designed to be, for example, 2.0 m, and the outside diameter R1 of the pipe 6 is most preferably designed to be, for example, 22 mm. When the pipe 6 and the treatment device 50 are coupled to each other, preferably, the entire length from the pipe 6 to the treatment device 50 in the second direction D2 is, for example, 30 m or less. With this configuration, when the pipe 6 and the treatment device 50 are coupled to each other, the pipe 6 is less likely to be buckled when the treatment device 50 is pushed and pulled in the second direction D2.

### First Modification Example of the First Embodiment

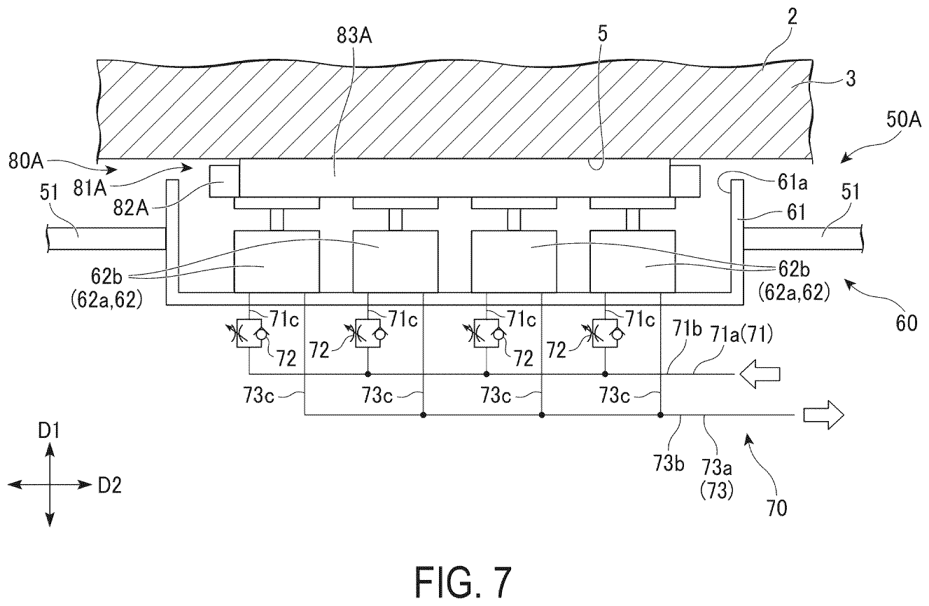

A first modification example of the first embodiment will be described with reference to FIG. 7.

A treatment device 50A of the present modification example is used for a cleaning treatment performed at a stage preceding the seal repairing treatment described above. As illustrated in FIG. 7, the treatment device 50A includes the pressing device 60 and a treatment portion 80A, and the treatment portion 80A is a cleaning portion 81A that cleans the treatment target surface 5. The treatment device 50A of the present modification example can be attached to the treatment system 1 in place of the treatment device 50 of the first embodiment.

The cleaning portion 81A includes a base 82A and a waste cloth 83A.

The base 82A is placed on the plurality of pressing portions 62 (the fluid devices 62a). The base 82A extends in the second direction D2.

The waste cloth 83 A is wound around a central portion of the base 82A in the second direction D2. The waste cloth 83A covers a surface of the base 82A on a side opposite to the pressing portions 62 in the first direction D1.

The base 82A may be divided in the second direction D2, and the waste cloth 83A may be attached to each of the divided bases 82A.

By reciprocating the treatment device 50A in the second direction D2 in a state in which the waste cloth 83A with a solvent adhered thereto is pressed against the treatment target surface 5, the treatment target surface 5 can be cleaned while a pressing force is uniformly applied to the treatment target surface 5.

### Second Modification Example of the First Embodiment

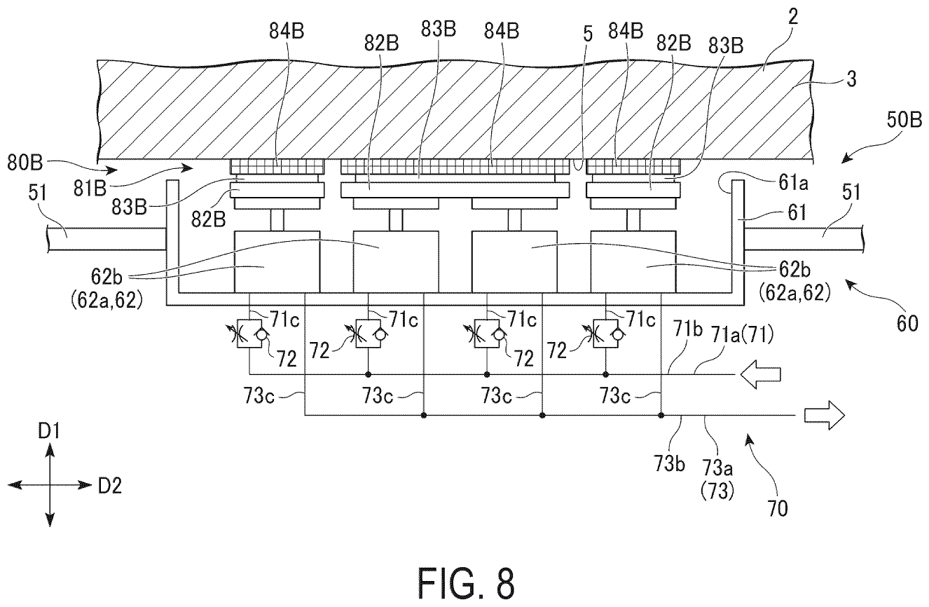

A second modification example of the first embodiment will be described with reference to FIG. 8.

A treatment device 50B of the present modification example is used for a sanding treatment performed at a stage preceding the seal repairing treatment described above. As illustrated in FIG. 8, the treatment device 50B includes the pressing device 60 and a treatment portion 80B, and the treatment portion 80B is a sanding portion 81B that polishes and smoothens the treatment target surface 5. The treatment device 50B of the present modification example can be attached to the treatment system 1 in place of the treatment device 50 of the first embodiment.

The sanding portion 81B includes a base 82B, a bonding portion 83B, and a scotch 84B.

The base 82B is placed on the plurality of pressing portions 62 (the fluid devices 62a). The base 82B is divided in the second direction D2. In the illustrated example, the base 82B is divided into three portions. The base 82B located at the center in the second direction D2 is provided so as to bridge the two pressing portions 62, and the bases 82B at both ends in the second direction D2 are provided so as to correspond to one pressing portion 62, respectively.

Each of the bases 82B is provided with the bonding portion 83B. The bonding portion 83B is provided on a surface of the base 82B on a side opposite to the pressing portion 62. The bonding portion 83B is formed to have substantially the same size as the corresponding base 82B. The scotch 84B is provided at each of the bonding portions 83B. The bonding portion 83B bonds the scotch 84B to the base 82B.

The scotch 84B is provided on a surface of the bonding portion 83B on a side opposite to the base 82B. The scotch 84B is formed to have substantially the same size as the corresponding base 82B and the corresponding bonding portion 83B.

By reciprocating the treatment device 50B in the second direction D2 in a state in which the scotch 84B is pressed against the treatment target surface 5, the treatment target surface 5 can be polished and smoothened while a pressing force is uniformly applied to the treatment target surface 5.

Each of the base 82B, the bonding portion 83B, and the scotch 84B may be one member extending in the second direction D2 without being divided in the second direction D2.

### Third Modification Example of the First Embodiment

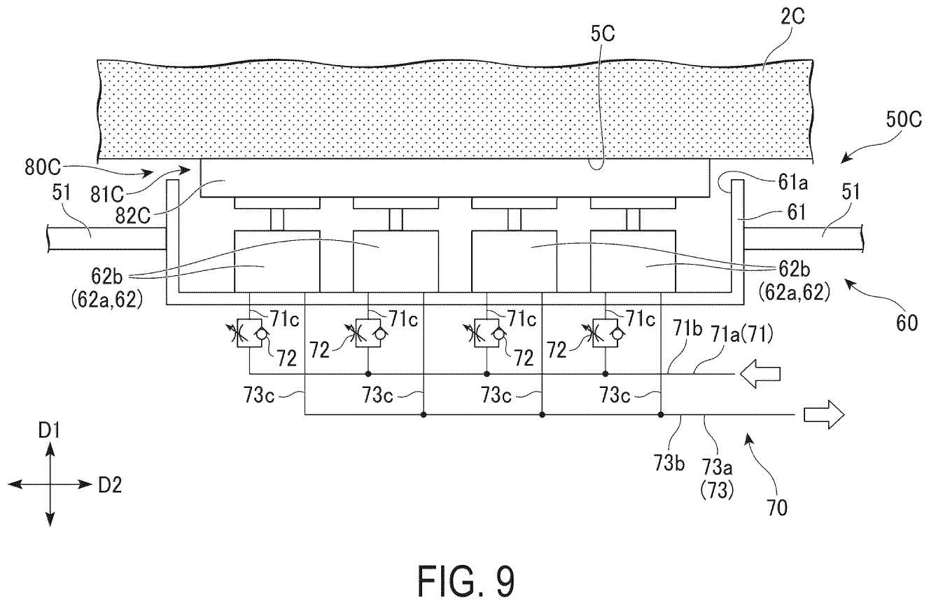

A third modification example of the first embodiment will be described with reference to FIG. 9.

A treatment device 50C of the present modification example is used for a compaction treatment in which a treatment target surface 5C of a target object 2C is compacted to be hardened. As illustrated in FIG. 9, the treatment device 50C includes the pressing device 60 and a treatment portion 80C, and the treatment portion 80C is a compactor portion 81C that compacts the treatment target surface 5C of the target object 2C to be hardened.

The compactor portion 81C includes a pressing platen 82C.

The pressing platen 82C is placed on the plurality of pressing portions 62 (the fluid devices 62a). The pressing platen 82C extends in the second direction D2. By pressing the pressing platen 82C against the treatment target surface 5C of the target object 2C, the target object 2C can be hardened.

The pressing platen 82C may be divided in the second direction D2.

### Fourth Modification Example of the First Embodiment

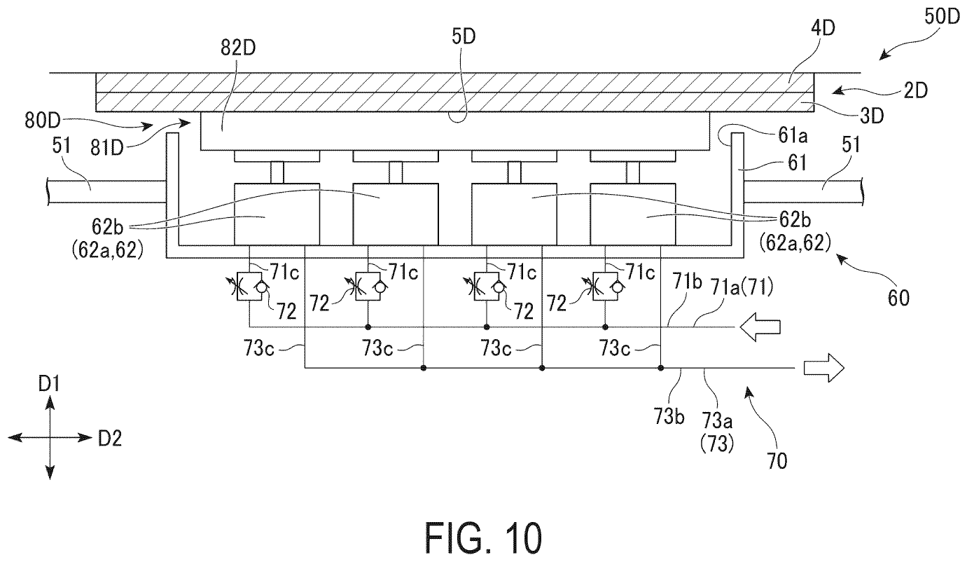

A fourth modification example of the first embodiment will be described with reference to FIG. 10.

A treatment device 50D of the present modification example is used for a fusing treatment (a welding treatment). As illustrated in FIG. 10, the treatment device 50D includes the pressing device 60 and a treatment portion 80D, and the treatment portion 80D is a fusing portion 81D (welding portion) that applies heat and pressure to a target object 2D including two boards 3D and 4D laid on top of each other to fuse (weld) the two boards 3D and 4D.

The fusing portion 81D includes a pressing platen 82D.

The pressing platen 82D is placed on the plurality of pressing portions 62 (the fluid devices 62a). The pressing platen 82D extends in the second direction D2. By pressing the pressing platen 82D against the board 3D (a treatment target surface 5D of the target object 2D) out of the two boards 3D and 4D laid on top of each other and heating the boards 3D and 4D, the two boards 3D and 4D can be fused.

### Second Embodiment

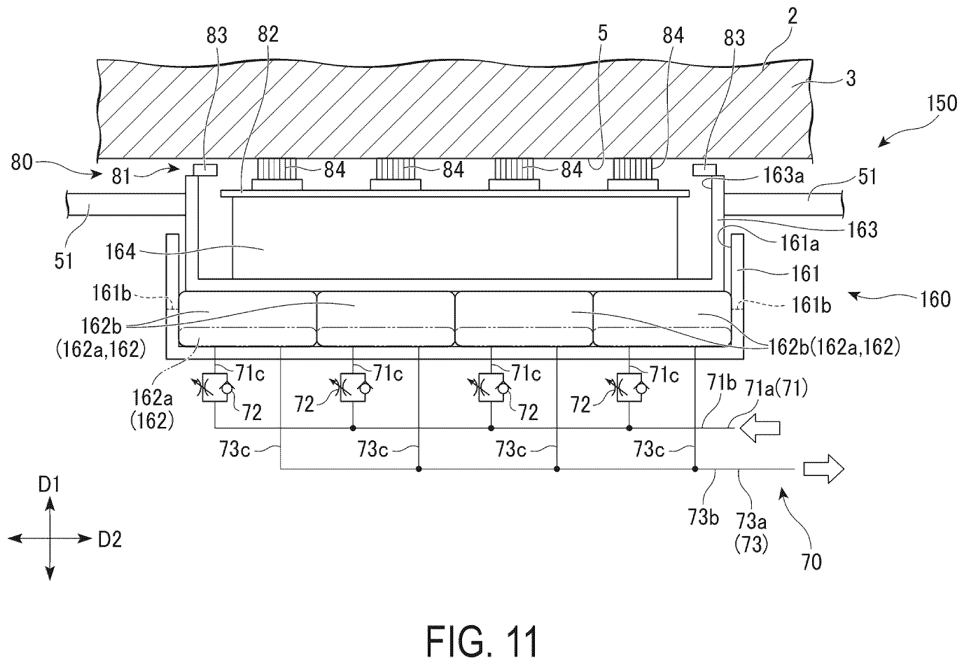

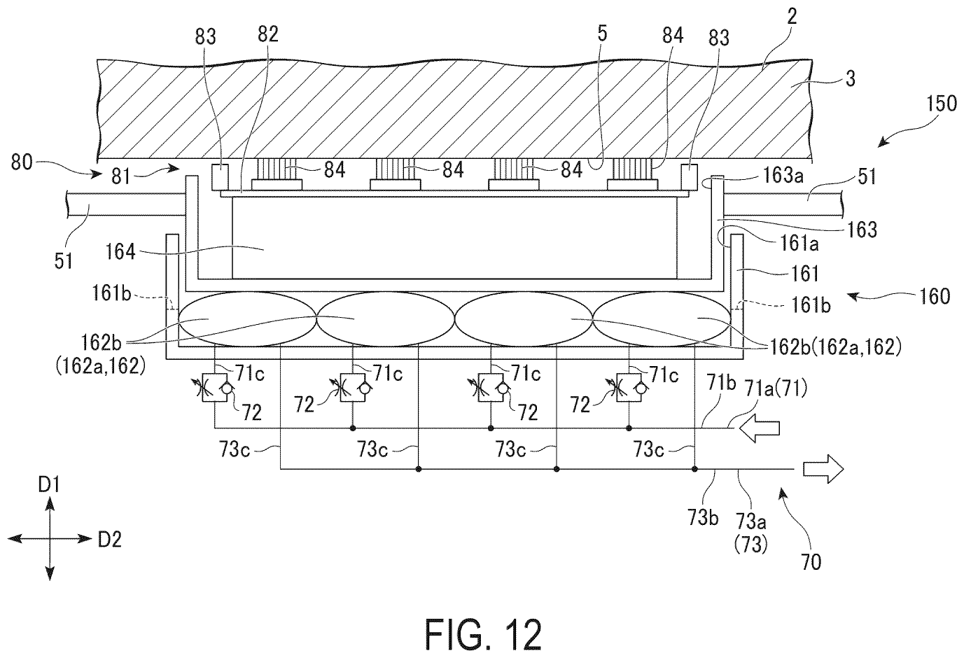

A second embodiment of the disclosure will be described below with reference to FIGS. 11 and 12. In the second embodiment, the same components as those of the first embodiment are denoted by the same reference signs or the like as those of the first embodiment, and the description thereof will be omitted as appropriate.

As illustrated in FIG. 11, a treatment device 150 of the present embodiment includes a pressing device 160, the treatment portion 80, and the coupling pipes 51.

The pressing device 160 includes a casing 161, a pressing portion 162 (a fluid device 162a), the interlocking mechanism 70, an inner casing 163, and an internal mechanism 164.

A lead-out hole 161b is formed at either end portion of the casing 161 in the second direction D2 so as to penetrate through the casing 161 in the second direction D2. The lead-out hole 161b is a recessed portion provided in the opening 161a of the casing 161.

The fluid device 162a of the present embodiment is a bag 162b that expands and contracts by the pressure of the internal fluid (air in the present embodiment) to generate a pressing force in the first direction D1 when expanding. The fluid accommodated in the bag 162b may be a fluid such as oil instead of air, but air is most preferable. Examples of the bag 162b include a rubber bag and a rubber balloon. A plurality of (four in the illustrated example) bag bodies 162b are accommodated in the casing 161. The plurality of bag bodies 162b are arranged side by side in the second direction D2 on the bottom surface of the casing 161 and are laid without gaps.

The inner casing 163 is accommodated in the casing 161 from the opening of the casing 161 and is placed on the plurality of bag bodies 162b. The inner casing 163 is formed in a box shape having an opening 163a that opens on the same side as the casing 161 in the first direction D1. In the present embodiment, the inner casing 163 is formed in a cubic shape extending in the second direction D2.

The inner casing 163 of the present embodiment is formed in the same shape as the casing 161 when viewed in the first direction D1 and is slidable with respect to the casing 161.

The internal mechanism 164 and the treatment portion 80 are accommodated in the inner casing 163. The internal mechanism 164 is disposed on the bottom surface of the inner casing 163, and the treatment portion 80 is mounted on the internal mechanism 164. The treatment portion 80 protrudes from the openings of the inner casing 163 and the casing 161 toward the treatment target surface 5 in the first direction D1. The internal mechanism 164 may be, for example, a mechanism that operates in the third direction to move the treatment portion 80 in the third direction or may be a base that simply causes the treatment portion 80 to protrude from the inner casing 163 and the casing 161.

In the present embodiment, the guide 83 is provided at either end portion of the opening 163a of the inner casing 163 in the second direction D2.

The coupling pipe 51 is provided at either end portion of the inner casing 163 in the second direction D2. The coupling pipe 51 is attached to a position overlapping the corresponding lead-out hole 161b of the casing 161 in the first direction D1. Thus, even when the bag bodies 162b contract and the bottom portion of the inner casing 163 approaches the bottom surface of the casing 161, contact between the coupling pipes 51 and the opening 163a of the casing 161 is avoided.

The treatment device 150 of the present embodiment is also used in the same procedure as that of the first embodiment and can apply the sealing material to the treatment target surface 5.

### Operational Effects

In the present embodiment, the following effects are achieved.

In the present embodiment, the fluid device 162a is the bag 162b that expands and contracts by the pressure of a fluid therein to generate a pressing force in the first direction D1 when expanding.

The pressing amount of each bag 162b in the first direction D1 is smoothly changed. Thus, by controlling the pressure of the fluid to each bag 162b, the shape of each bag 162b can be caused to follow the shape of the treatment target surface 5. Accordingly, a uniform pressing force can be generated with respect to the treatment target surface 5 regardless of the shape of the treatment target surface 5. That is, the followability to the treatment target surface 5 can be improved.

A pressing force in the first direction D1 can be generated with a simple configuration, allowing for downsizing. As illustrated in FIG. 12, even when the internal pressures of the bag bodies 162b are low and the shapes of the bag bodies 162b are not stable, since the plurality of bag bodies 162b are provided, a pressing force can be generated uniformly in a direction (the second direction in the present embodiment) intersecting the first direction D1.

Further, in the present embodiment, the casing 161 and the inner casing 163 form a double structure, and the treatment portion 80 is disposed in the inner casing 163. Disposing the plurality of bag bodies 162b between the inner casing 163 and the casing 161 allows a pressing force to be uniformly transmitted to the treatment portion 80 by the plurality of bag bodies 162b, allowing the treatment target surface 5 to be uniformly treated.

Also in the present embodiment, as in the first embodiment, in addition to the treatment portion 80 for coating the brush 84, the treatment portion 80A for cleaning treatment, the treatment portion 80B for sanding treatment, the treatment portion 80C for compaction treatment, and the treatment portion 80D for fusing treatment can be mounted.

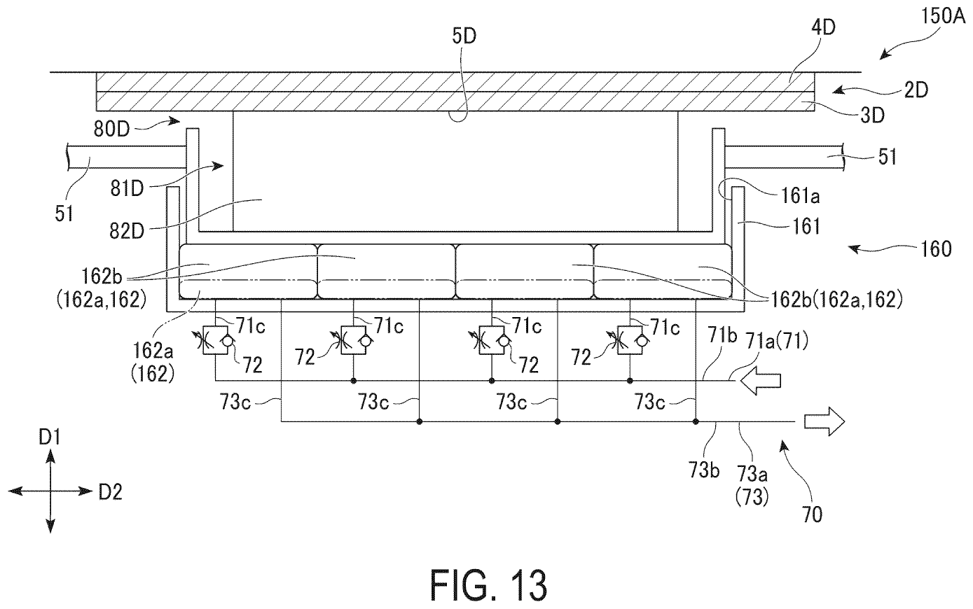

The pressing device 160 of the present embodiment can also deform each bag 162b while following the shape of the treatment target surface 5 of the target object 2, allowing, by using the pressing device 160 of the present embodiment in the treatment portion 80D for fusing treatment as illustrated in FIG. 13 in particular, the fusing treatment to be performed with high accuracy by following the shape of the treatment target surface 5D.

The pressing device 160 of the present embodiment may be used in the treatment portion 80C for compaction treatment. In that case as well, the compaction treatment can be performed with high accuracy by following the shape of the treatment target surface 5C.

In the case where the treatment target surface 5C or 5D is curved, the treatment target surface 5C or 5D can be more smoothly curved by dividing and providing the pressing platen 82C or 82D for each pressing portion 162.

### Third Embodiment

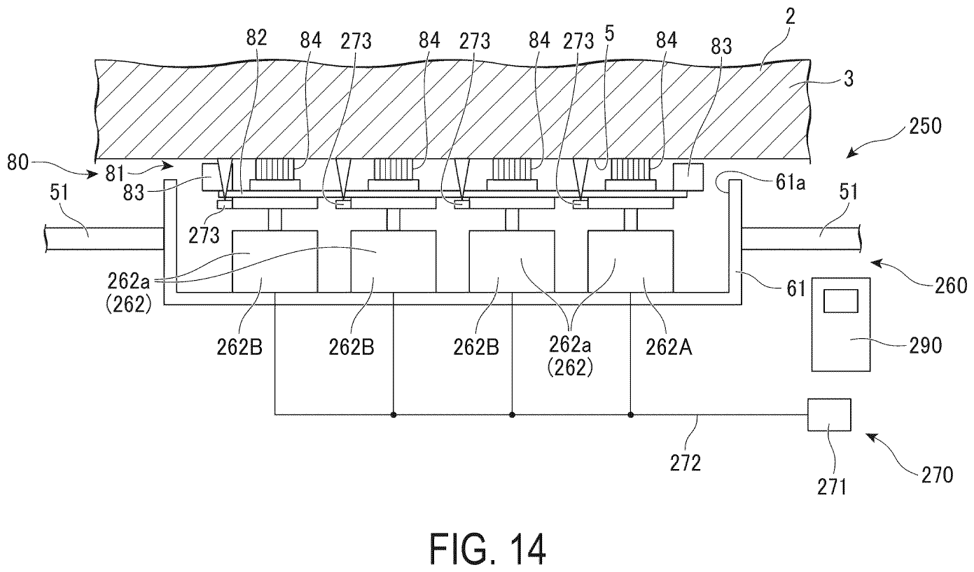

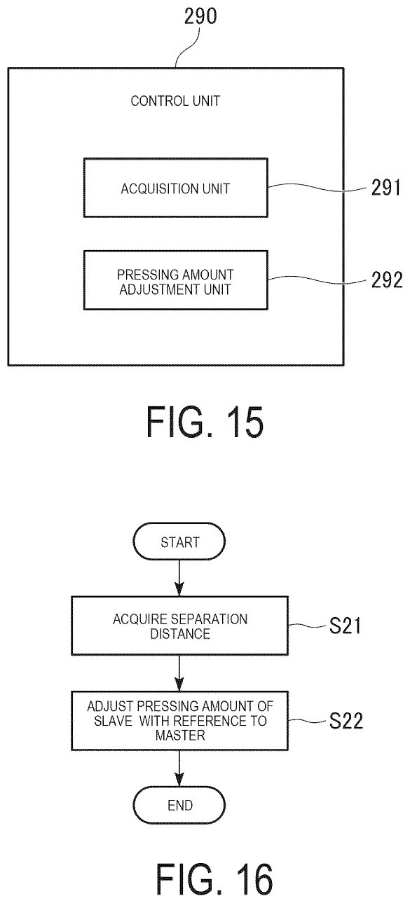

A third embodiment of the disclosure will be described below with reference to FIGS. 14 to 16. In the third embodiment, the same components as those of the first embodiment are denoted by the same reference signs or the like as those of the first embodiment, and the description thereof will be omitted as appropriate.

As illustrated in FIG. 14, a treatment device 250 of the present embodiment includes a pressing device 260, the treatment portion 80, and the coupling pipes 51.

The pressing device 260 includes the casing 61, a pressing portion 262, and an interlocking mechanism 270.

The pressing portion 262 of the present embodiment is an actuator 262a that is operated by electric power to generate a pressing force in the first direction D1. The interlocking mechanism 270 includes a power supply unit 271, a sensor 273, and a control unit 290.

The power supply unit 271 supplies electric power to each of a plurality of actuators 262a via, for example, a plurality of cables 272.

The sensor 273 is provided at each of the actuators 262a. The sensor 273 detects a separation distance between each actuator 262a and the treatment target surface 5. The sensor 273 is a non-contact sensor that detects a separation distance between the actuator 262a and the treatment target surface 5 by, for example, irradiating the treatment target surface 5 with a laser. The sensor 273 may be a contact sensor such as a force sensor.

The control unit 290 controls the pressing amount of the actuator 262a in the first direction D1 in response to a detection value of the sensor 273. The control unit 290 includes functional units of an acquisition unit 291 and a pressing amount adjustment unit 292.

The acquisition unit 291 acquires the detection value of the sensor 273.

The pressing amount adjustment unit 292 adjusts the pressing amount of the actuator 262a in the first direction D1 in response to the detection value of the sensor 273.

The treatment device 250 of the present embodiment is also used in the same procedure as that of the first embodiment and can apply the sealing material to the treatment target surface 5. In the present embodiment, the pressing amount of each actuator 262a can be adjusted in real time during the operation of the pressing device 260.

### Real Time Adjustment of Pressing Amount

Next, a control procedure of real-time adjustment of the pressing amount will be described with reference to the flowchart of FIG. 16.

In the control unit 290, one actuator 262a of the plurality of actuators 262a serving as a reference is set in advance as a master 262A, and the remaining actuators 262a are set in advance as slaves 262B that follow the master 262A.

First, the acquisition unit 291 acquires a separation distance between the actuator 262a and the treatment target surface 5 from each sensor 273 (step S21). Then, the pressing amount adjustment unit 292 adjusts the pressing amount of each slave 262B with reference to the master 262A in response to the detection value of the sensor 273 (step S22). This causes the pressing amounts of all the actuators 262a to coincide with each other.

This operation is repeated at short intervals during the operation of the pressing device 260. In this way, the pressing amounts of all the actuators 262a are adjusted in real time.

### Operational Effects

In the present embodiment, the following effects are achieved.

In the present embodiment, the pressing portion 262 is the actuator 262a that is operated by electric power to generate a pressing force in the first direction D1. The interlocking mechanism 270 includes the power supply unit 271 that supplies electric power to each of the plurality of actuators 262a, the sensor 273 that is provided for each of the actuators 262a and detects a separation distance between each of the actuators 262a and the treatment target surface 5, and the control unit 290 that controls the pressing amount of each of the actuators 262a in the first direction D1 in response to the detection value of the sensor 273.

This can immediately control the pressing amount of each of the actuators 262a in response to a change in the separation distance between the treatment target surface 5 and each of the actuators 262a. In this way, the pressing amount of each actuator 262a is controlled in real time during the operation of the pressing device 260 to allow the treatment (seal repairing treatment in the present embodiment) to be performed on the treatment target surface 5 with high accuracy.

Also in the present embodiment, as in the first embodiment, in addition to the treatment portion 80 for coating the brush 84, the treatment portion 80A for cleaning treatment, the treatment portion 80B for sanding treatment, the treatment portion 80C for compaction treatment, and the treatment portion 80D for fusing treatment can be mounted.

### Hardware Configuration

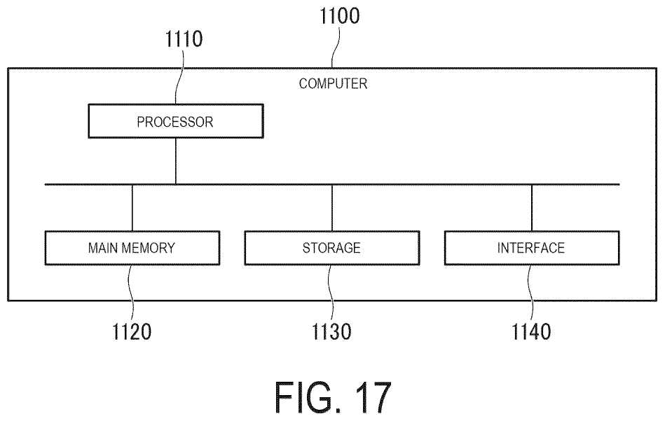

The control unit 290 of the above-described embodiment is implemented in a computer as illustrated in FIG. 17. FIG. 17 is an example of a schematic block diagram illustrating the configuration of a computer in which the control unit 290 according to each embodiment is implemented. A computer 1100 includes a processor 1110, a main memory 1120, a storage 1130, and an interface 1140.

The operation of each functional unit of the control unit 290 is stored in the storage 1130 in the form of a program. The processor 1110 reads the program from the storage 1130, deploys the program in the main memory 1120, and executes the processing described above according to the program. The processor 1110 secures a storage area in the main memory 1120 according to the program.

The program may be a program for achieving some of the functions that the computer 1100 is caused to perform. For example, the program may be one that achieves a function in combination with another program already stored in the storage 1130, or in combination with another program implemented in another device. The computer 1100 may include a custom large-scale integrated circuit (LSI) such as a programmable logic device (PLD) in addition to or in place of the configuration described above. Examples of the PLD include a programmable array logic (PAL), a generic array logic (GAL), a complex programmable logic device (CPLD), and a field programmable gate array (FPGA). In that case, part or all of the functions implemented by the processor 1110 may be implemented by the integrated circuit.

Examples of the storage 1130 include a magnetic disk, a magneto-optic disk, and a semiconductor memory. The storage 1130 may be an internal medium directly connected to a bus of the computer 1100 or may be an external medium connected to the computer 1100 via the interface 1140 or a communication line. When this program is delivered to the computer 1100 via a communication line, the computer 1100 after receiving the delivery may deploy the program in the main memory 1120 and execute the processing described above. The storage 1130 may be a non-temporary tangible storage medium.

The program may be a program for achieving some of the functions described above. Further, the program may be a so-called differential file (differential program) that achieves the functions described above in combination with another program already stored in the storage 1130.

### Other Embodiments

An embodiment according to the disclosure has been described in detail with reference to the drawings. However, the specific configuration of the disclosure is not limited to this embodiment. Design change without departing from the main gist of the disclosure or the like is also included.

In the above-described embodiment, a case in which the automation device 10 moves the treatment device 50, 50A, 50B, 50C, 50D, 150, or 250 in the second direction D2 has been described, but the disclosure is not limited thereto. For example, two or more operators may hold each of the two pipes 6 extending from both sides in the second direction D2 of the treatment device 50, 50A, 50B, 50C, 50D, 150, or 250, and manually move the treatment device 50, 50A, 50B, 50C, 50D, 150, or 250 in the second direction D2. In the case of manual operation, graduations or marks may be provided on the pipes 6 or a mechanism for holding the pipes 6 (for example, the base 15a of the movement mechanism 15) so that the treatment portion 80, 80A, 80B, 80C, or 80D can be reciprocated within an accurate operation range. Instead of the pipes 6, a wire (two wires in total) may be provided on either side of the treatment device 50, 50A, 50B, 50C, 50D, 150, or 250 in the second direction D2 (front-back direction), and the two wires may be pulled in the second direction D2 so as to move the treatment device 50, 50A, 50B, 50C, 50D, 150, or 250 in the second direction D2.

### Supplementary Notes

The pressing device 60, 160, or 260, the treatment device 50, 50A, 50B, 50C, 50D, 150, or 250, and the treatment system 1 described in each embodiment are grasped as follows, for example.

(1) A pressing device 60, 160, or 260 according to a first aspect includes: a plurality of pressing portions 62, 162, or 262 each configured to generate a pressing force toward a treatment target surface 5, 5C, or 5D facing in a first direction D1 and arranged in a direction intersecting the first direction D1; and an interlocking mechanism 70 or 270 configured to interlock the plurality of pressing portions 62, 162, or 262 and control a pressing amount of each of the pressing portions 62, 162, or 262 in the first direction D1. This can generate a pressing force in the first direction D1 uniformly in the direction intersecting the first direction D1.

(2) A pressing device 60 or 160 according to a second aspect may be the pressing device 60 or 160 of (1). The pressing portions 62 or 162 may respectively be fluid devices 62a or 162a configured to be deformed by a pressure of an internal fluid to generate a pressing force in the first direction D1, and the interlocking mechanism 70 or 270 may include a fluid supply portion 71 configured to supply a fluid to each of the plurality of fluid devices 62a or 162a and a plurality of speed control valves 72 provided for the respective plurality of the fluid devices 62a or 162a and adjust a supply rate of the fluid to each of the fluid devices 62a or 162a.

Before the pressing device 60 or 160 is installed at a position facing the treatment target surface 5, 5C, or 5D, the speed control valves 72 can be operated to control the supply rate of the fluid to each of the fluid devices 62a or 162a and the internal pressure of each of the fluid devices 62a or 162a.

(3) A pressing device 60 according to a third aspect may be the pressing device 60 of (2). The fluid device 62a may be fluid cylinder 62b configured to expand and contract in the first direction D1 by the pressure of the internal fluid to generate a pressing force in the first direction D1 when expanding.

The fluid cylinders 62b are deformed only in the first direction D1 by the pressure of the fluid. Thus, the pressure of the fluid can be efficiently converted into a pressing force.

(4) A pressing device 160 according to a fourth aspect may be the pressing device 160 of (2). The fluid device 162a may be a bag 162b configured to expand and contract in the first direction D1 by the pressure of the internal fluid to generate a pressing force in the first direction D1 when expanding.

The pressing amount of each bag 162b in the first direction D1 is smoothly changed. Thus, by controlling the pressure of the fluid to each bag 162b, the shape of each bag 162b can be caused to follow the shape of the treatment target surface 5, 5C, or 5D. Accordingly, a uniform pressing force can be generated with respect to the treatment target surface 5, 5C, or 5D regardless of the shape of the treatment target surface 5, 5C, or 5D. That is, the followability to the treatment target surface 5, 5C, or 5D can be improved.

(5) A pressing device 260 according to a fifth aspect may be the pressing device 260 of (4). The pressing portion 262 may be an actuator 262a configured to be operated by electric power to generate a pressing force in the first direction D1, and the interlocking mechanism 270 may include a power supply unit 271 configured to supply electric power to a plurality of the actuators 262a, a sensor 273 provided for each of the actuators 262a and configured to supply detect a separation distance between each of the actuators 262a and the treatment target surface 5, 5C, or 5D, and a control unit 290 that controls a pressing amount of each of the actuators 262a in the first direction D1 in response to a detection value of the sensor 273.

This allows the pressing amount of each of the actuators 262a to be immediately controlled in response to changes in the separation distance between the treatment target surface 5, 5C, or 5D and each actuator 262a.

(6) A treatment device 50, 50A, 50B, 50C, 50D, 150, or 250 according to a sixth aspect includes the pressing device 60, 160, or 260 of (5), a treatment portion 80, 80A, 80B, 80C, or 80D configured to treat the treatment target surface 5, 5C, or 5D by being applied with a pressing force in the first direction D1 and pressed against the treatment target surface 5, 5C, or 5D by the pressing portions 62, 162, or 262.

This allows the treatment portion 80, 80A, 80B, 80C, or 80D to be pressed against the treatment target surface 5, 5C, or 5D while the orientation of the treatment portion 80, 80A, 80B, 80C, or 80D is maintained such that a surface of the treatment portion 80, 80A, 80B, 80C, or 80D on the treatment target surface 5, 5C, or 5D side is parallel to the treatment target surface 5, 5C, or 5D. Thus, the treatment portion 80, 80A, 80B, 80C, or 80D can be uniformly pressed against the treatment target surface 5, 5C, or 5D to uniformly treat the entire treatment target surface 5, 5C, or 5D.

Examples of the treatment include a treatment of applying a sealing material to the treatment target surface 5 (for example, the above-described seal repairing treatment), a cleaning treatment of cleaning the treatment target surface 5, a sanding treatment of polishing and smoothening the treatment target surface 5, a fusing treatment, a compaction treatment, and the like, which are performed in repairing a wing of an aircraft.

(7) A treatment device 50, 150, or 250 according to a seventh aspect may be the treatment device 50, 150, or 250 of (6). The treatment portion 80 may be a brush portion 81 including brushes 84 extending toward the treatment target surface 5 and configured to apply a sealing material to the treatment target surface 5.

This allows all the brushes 84 to be brought into contact with the treatment target surface 5 in the same orientation, so that the sealing material can be uniformly applied.

(8) A treatment system 1 according to an eighth aspect may include: the treatment device 50, 50A, 50B, 50C, 50D, 150, or 250 of (6) or (7); a pipe 6 coupled to the treatment device 50, 50A, 50B, 50C, 50D, 150, or 250 in a second direction D2 intersecting the first direction D1; and a movement mechanism 15 that holds an end portion of the pipe 6 on a side opposite to the treatment device 50, 50A, 50B, 50C, 50D, 150, or 250 in the second direction D2 and moves the pipe 6 in the second direction D2.

This allows the positioning of the treatment device 50, 50A, 50B, 50C, 50D, 150, or 250 in the second direction D2 and the operation of moving the treatment portion 80, 80A, 80B, 80C, or 80D in the second direction D2 in a state of being pressed against the treatment target surface 5 to be automatically performed.

(9) A treatment system 1 according to a ninth aspect is the treatment system 1 of (8), wherein the treatment device 50, 50A, 50B, 50C, 50D, 150, or 250 may further include a coupling pipe 51 extending in the second direction D2 and may further include a coupling member 20 that couples the pipe 6 and the coupling pipe 51. The coupling member 20 may include: a central shaft portion 21 that extends in the second direction D2 and has one end portion in the second direction D2 inserted into one of the pipe 6 and the coupling pipe 51 and the other end portion in the second direction D2 inserted into the other of the pipe 6 and the coupling pipe 51; male thread portions 22 provided at both the end portions of the central shaft portion 21 in the second direction D2 and threadably engaged with inside surfaces of the pipe 6 and the coupling pipe 51; and a flange portion 23 that protrudes from an outside surface of the central shaft portion 21 at a central portion in the second direction D2 outward in a radial direction with respect to the pipe 6 and the coupling pipe 51.

The coupling member 20 is firmly fixed to both the pipe 6 and the coupling pipe 51 of the treatment device 50, 50A, 50B, 50C, 50D, 150, or 250 by the male thread portions 22. The flange portion 23 protrudes outward in the radial direction beyond the pipe 6 and the coupling pipe 51. Thus, the pipe 6 and the coupling pipe 51 can be prevented from colliding with the treatment target surface 5 and the like.

While preferred embodiments of the invention have been described as above, it is to be understood that variations and modifications will be apparent to those skilled in the art without departing from the scope and spirit of the invention. The scope of the invention, therefore, is to be determined solely by the following claims.

1. A pressing device, comprising:
a plurality of pressing portions each configured to generate a pressing force toward a treatment target surface facing in a first direction and arranged in a direction intersecting the first direction; and
an interlocking mechanism configured to interlock the plurality of pressing portions and control a pressing amount of each of the pressing portions in the first direction.

2. The pressing device according to claim 1, wherein
each of the pressing portions is a fluid device configured to be deformed by a pressure of an internal fluid to generate the pressing force in the first direction, and
the interlocking mechanism includes
a fluid supply portion configured to supply a fluid to a plurality of the fluid devices and
a plurality of speed control valves provided for the respective plurality of the fluid devices and configured to adjust a supply rate of the fluid to each of the fluid devices.

3. The pressing device according to claim 2, wherein the fluid device is a fluid cylinder configured to expand and contract in the first direction by the pressure of the internal fluid to generate the pressing force in the first direction when expanding.

4. The pressing device according to claim 2, wherein the fluid device is a bag configured to expand and contract by the pressure of the internal fluid to generate the pressing force in the first direction when expanding.

5. The pressing device according to claim 1, wherein
each of the pressing portions is an actuator configured to be operated by electric power to generate the pressing force in the first direction, and
the interlocking mechanism includes
a power supply unit configured to supply electric power to a plurality of the actuators,
a sensor provided for each of the actuators and configured to detect a separation distance between each of the actuators and the treatment target surface, and
a control unit configured to control a pressing amount of each of the actuators in the first direction in response to a detection value of the sensor.

6. A treatment device, comprising:
the pressing device according to claim 1; and
a treatment portion configured to treat the treatment target surface by being applied with the pressing force in the first direction and pressed against the treatment target surface by the pressing portions.

7. The treatment device according to claim 6, wherein the treatment portion is a brush portion including a brush extending toward the treatment target surface and configured to apply a sealing material to the treatment target surface.

8. A treatment system, comprising:
the treatment device according to claim 6;
a pipe coupled to the treatment device from a second direction intersecting the first direction; and
a movement mechanism configured to hold an end portion of the pipe on a side opposite to the treatment device in the second direction and move the pipe in the second direction.

9. The treatment system according to claim 8, wherein
the treatment device further includes a coupling pipe extending in the second direction and further includes a coupling member configured to couple the pipe and the coupling pipe,
the coupling member includes
a central shaft portion that extends in the second direction and has one end portion in the second direction inserted into one of the pipe and the coupling pipe and the other end portion in the second direction inserted into the other of the pipe and the coupling pipe,
male thread portions provided at both the end portions of the central shaft portion in the second direction and threadably engaged with inside surfaces of the pipe and the coupling pipe, and
a flange portion protruding from an outside surface of the central shaft portion at a central portion in the second direction outward in a radial direction with respect to the pipe and the coupling pipe.
